(19) United States
(12) Patent Application Publication
(10) Pub. No.: US 2026/0295725 A1
(43) Pub. Date: Oct. 1, 2026

(54) METHOD AND APPARATUS FOR ALIGNMENT OF WORKPIECE

(71) Applicant: ORC MANUFACTURING CO., LTD., Tokyo (JP)

(72) Inventors: Jin SATO, Tokyo (JP); Akira NAKAZAWA, Tokyo (JP)

(73) Assignee: ORC MANUFACTURING CO., LTD., Tokyo (JP)

(21) Appl. No.: 19/286,808

(22) Filed: Jul. 31, 2025

(30) Foreign Application Priority Data
Mar. 26, 2025 (JP) 2025-050972

(51) Int. Cl. B23K 26/08

(52) U.S. Cl. CPC B23K 26/083

(57) ABSTRACT

A method for alignment of a workpiece includes: a) arranging a plurality of alignment cameras for a processing unit used in processing a workpiece; b) setting a plurality of subdivision areas in the workpiece based on an array of alignment marks formed on the workpiece; and c) capturing alignment marks included in a subdivision area by a common alignment camera used for respective subdivision areas.

### BACKGROUND OF THE INVENTION

### 1. Field of the Invention

The present invention relates to the alignment of a workpiece that is processed in a processing unit associated with a semiconductor such as a laser-processing unit, an exposure unit (photolithography system), etc.

### 2. Description of the Related Art

In a processing unit such as a laser-processing unit, photolithography system, etc., an alignment of a workpiece is carried out. Alignment marks formed on a substrate are captured by alignment cameras and the workpiece is aligned based on the measured positions of the alignment marks. The deformation of a workpiece varies with material(s) or the size of the workpiece, and the degree of expansion/shrinkage can differ in different areas of the workpiece. To enhance accuracy of alignment, an increase in the number of alignment marks and an alignment to each region of the workpiece are required.

KANEDA (WO2013/114593) discloses a laser-processing unit that divides a processed area on a substrate into a plurality of areas or regions and calculates collection values for alignment in each region. REE et al. (WO2012/124517) discloses an exposure unit that determines the number of alignment cameras in accordance to the number of alignment marks formed around a processed area on a workpiece to capture the alignment marks effectively.

As the size of a substrate is enlarged, the miniaturization of a pattern becomes necessary. Accordingly, the number of alignment marks and the number of subdivision areas increase, which extends a measurement time and lowers productivity. Since alignment marks are captured by several alignment cameras, accuracy of alignment deteriorates due to an individual variation of each alignment camera.

### SUMMARY OF THE INVENTION

The present invention is directed at the improvement of alignment of a workpiece associated with a semiconductor.

A method for alignment of a workpiece according to one aspect of the present invention includes: a) arranging a plurality of alignment cameras for a processing-unit used in processing a workpiece; b) setting a plurality of subdivision areas in the workpiece based on array of alignment marks formed on the workpiece; and c) capturing alignment marks included in a subdivision area by a common alignment camera used for respective subdivision areas.

An apparatus for alignment of a workpiece according to another aspect of the present invention includes: a plurality of alignment cameras configured to be arranged spaced apart from one another at a predetermined interval corresponding to a center interval between neighboring subdivision areas that are defined on the workpiece; a processing stage on which the workpiece is mounted; and a controller configured to control the alignment process. The controller controls the processing stage or the plurality of alignment cameras to capture alignment marks included in a subdivision area by a common alignment camera used for respective subdivision areas.

### BRIEF DESCRIPTION OF THE DRAWINGS

The present invention will be better understood from the description of the preferred embodiment of the invention set forth below together with the accompanying drawings, in which:

FIG. 1 is a schematic view of a laser-processing unit according to an embodiment;

FIG. 2 illustrates an arrangement of alignment cameras;

FIG. 3 illustrates a substrate W subdivided in accordance to an arrangement of alignment marks;

FIG. 4 is a flowchart of a laser ablation process including an alignment process;

FIG. 5 illustrates a shooting method different from that shown in FIG. 3;

FIG. 6 illustrates a substrate with a greater density of alignment marks compared to the alignment marks shown in FIG. 3;

FIGS. 7A and 7B illustrate a substrate in which alignment marks are positioned differently from those shown in FIG. 3;

FIGS. 8A and 8B illustrate a substrate in which alignment marks are in positions different from those shown in FIG. 3;

FIG. 9 illustrates a substrate in which positions of alignment marks vary with respect to subdivision areas; and

FIG. 10 is a schematic view of an exposure unit according to another embodiment.

### DESCRIPTION OF THE PREFERRED EMBODIMENTS

Hereinafter, the preferred embodiment of the present invention is described with references to the attached drawings.

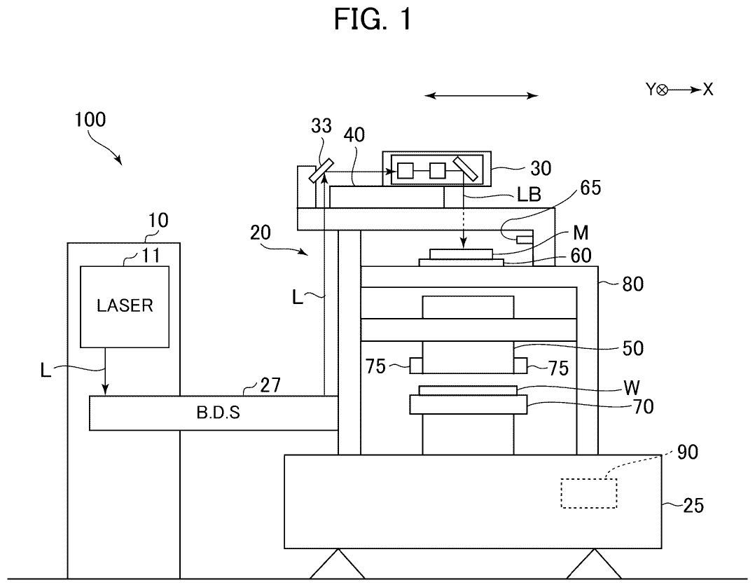

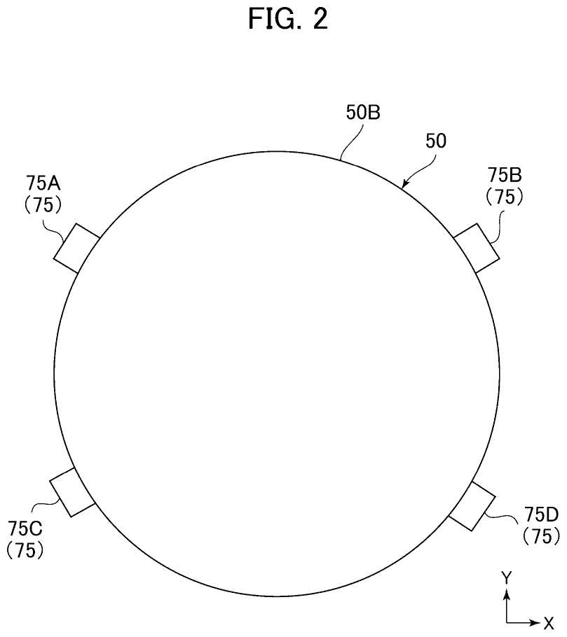

FIG. 1 is a schematic view of a laser-processing unit according to the embodiment. FIG. 2 illustrates an arrangement of alignment cameras.

The laser-processing unit 100, which forms a pattern on a substrate W by laser ablation, is equipped with a light source unit 10 and a body 20. The light source unit 10 is mounted on the floor independently from the body 20.

The light source unit 10 is equipped with a laser 11 that oscillates a laser beam L with high energy density. Herein, the laser 11 is an excimer laser that emits a KrF excimer laser beam with the wavelength of 248 nm per pulse. The emitted laser beam L is directed toward the body 20 via a beam delivery system 27.

The body 20 is equipped with an illumination optical unit 30, a scanning mechanism 40, a projection optical system 50, a mask stage 60 and a processing stage 70, which are supported by a supporting structure 80 in the body 20. The frame-shaped supporting structure 80, which has four legs that extend toward the floor and are evenly spaced and opposite to one another, is mounted on the base 25 of the body 20. A mask M is mounted on the mask stage 60 and the substrate W is mounted on the processing stage 70.

The illumination optical unit 30 is equipped with a line-beam forming optical system (not shown) including a cylindrical lens, an angle-switching mirror, etc. The line-beam forming optical system forms a line-shaped laser beam LB from the laser beam L that enters the illumination optical unit 30 along the scanning direction via a mirror 33. The line-shaped laser beam LB is directed toward the mask M via a mirror (not shown).

The scanning mechanism 40 may move the illumination optical unit 30 along the main-scanning direction at a given speed. Accordingly, the line-shaped laser beam LB, which is perpendicular to the scanning direction, is moved relative to the mask M and the projection optical system 50 along the main-scanning direction. Thus, the mask M mounted on the mask stage 60 and the substrate W mounted on the processing stage 70 are scanned, respectively. Herein, the X axis and Y axis are defined along the main-scanning direction and the sub-scanning direction, respectively. Also, the Z axis is defined along the vertical direction.

The mask stage 60, which supports the mask M, may move the mask M along the X-axis and Y-axis directions and rotate the mask M around the Z-axis direction to position the mask M in a given position. The projection optical system 50, which has focus points on the surfaces of the mask M and the substrate W, projects a beam passing through the mask M to the substrate W as a light pattern. Herein, the projection optical system 50 is a reduced-lens optical system, which has a projection magnification less than 1 (e.g., 0.25).

In the substrate W, a copper wiring layer is formed on an epoxy resin and an insulation layer is further formed on the copper wiring layer. As described above, the laser light source 10 emits the excimer laser beam with high energy density towards the substrate W, which ablates, i.e., removes material from the substrate W so that a pattern corresponding to a mask pattern (hereinafter, “processed pattern”) is formed on the substrate W.

As for a processed pattern, a through hole, blind via hole, wiring groove (trench), etc., can be formed on the substrate W. After the laser ablation process for the substrate W is finished, the substrate W is filled with a conductor such as copper.

A plurality of alignment cameras (hereinafter, called “alignment camera group” as needed) 75 are mounted on the lens barrel 50B of the projection optical system 50. The alignment cameras 75 capture alignment marks formed on the substrate W mounted on the processing stage 70. As shown in FIG. 2, four alignment cameras 75A, 75B, 75C and 75D are herein arranged around the circumference of the lens barrel 50B, which are evenly spaced from one another. An alignment camera 65 mounted on the supporting structure 80 captures alignment marks formed on the mask M.

The laser-processing unit 100 has a controller 90 that controls a laser ablation process. When an input operation for a laser ablation process is carried out by an operator, the controller controls the light source 10, the scanning mechanism 40, the processing stage 70, etc., to scan the line-shaped laser beam LB along the main-scanning direction (the X-axis direction).

The controller 90 further controls an alignment process. The controller 90 moves the mask stage 60 and the processing stage 70 to predetermined positions, respectively, and moves the alignment cameras 75 and the alignment camera 65 to capture alignment marks formed on the substrate W and the mask M. Based on the measured position coordinates of the alignment marks on the substrate W, the controller 90 adjusts the position of the substrate W by moving the processing stage 70.

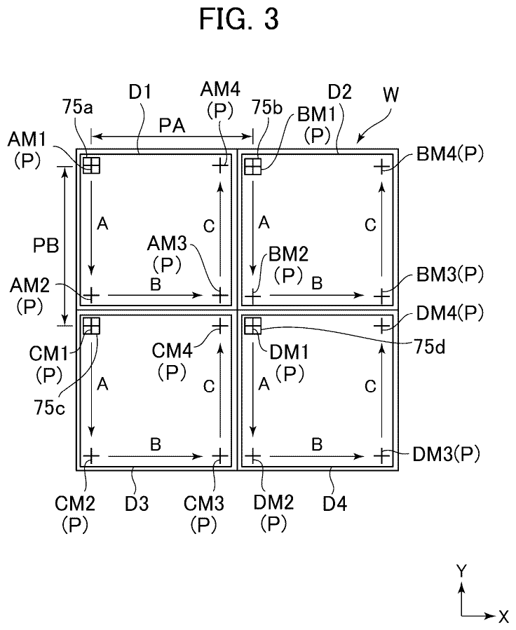

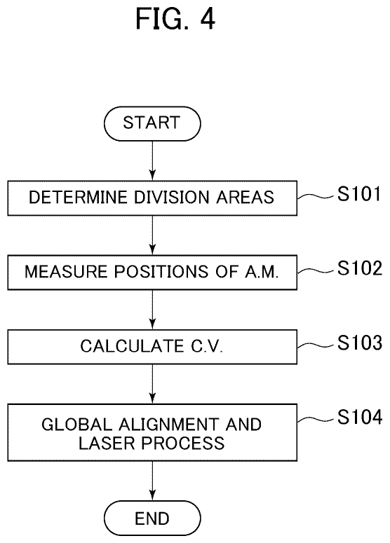

FIG. 3 illustrates a substrate W subdivided in accordance to an arrangement of alignment marks. FIG. 4 is a flowchart of a laser ablation process including an alignment process. Hereinafter, the movements of the alignment camera group 75 during an alignment process are explained.

A plurality of cross-shaped alignment marks P are provided on the substrate W. Note that the alignment marks P may have a shape other than a cross-shape. The size of the substrate W depends on a standard/specification. Herein, the size of the substrate W is set to 500 mm×500 mm, which belongs to a large-sized substrate.

In a relatively large substrate W, four areas for an alignment are defined. The four areas D1, D2, D3 and D4 are defined by dividing the total area of the substrate W into quarters (hereinafter, each area is called a “subdivision area”). The alignment marks P are positioned at the corners of each subdivision area. The alignment marks P positioned at the corner of the subdivision area D1 are represented by the alphanumeric references “AM1, AM2, AM3 and AM4,” as needed. Similarly, the alignment marks P positioned at the corners of the subdivision area D2 are represented by the alphanumeric references “BM1, BM2, BM3 and BM4,” the alignment marks P positioned at the corners of the subdivision area D3 are represented by the alphanumeric references “CM1, CM2, CM3 and CM4,” and the alignment marks P positioned at the corners of the subdivision area D4 are represented by the alphanumeric references “DM1, DM2, DM3 and DM4.”

Each alignment mark P is positioned at the corner of a corresponding subdivision area and the distance between the center position of each alignment mark P and boundaries of the corresponding subdivision area is equal. A distance between an alignment mark P in a subdivision area and a corresponding alignment mark P in a neighboring subdivision area is set to “PA” in the X-axis direction and “PB” in the Y-axis direction.

Concretely speaking, the distance between the alignment mark AM1 in the subdivision area D1 and the alignment mark BM1 in the subdivision area D2 is “PA” and the distance between the alignment mark CM1 in the subdivision area D3 and the alignment mark DM1 in the subdivision area D4 is also “PA”. Furthermore, the distance between the alignment mark AM1 in the subdivision area D1 and the alignment mark CM1 in the subdivision area D3 is “PB” and the distance between the alignment mark BM1 in the subdivision area D2 and the alignment mark DM1 in the subdivision area D4 is also “PB”. The distance “PA” and the distance “PB” substantially coincide with the center-to-center spacing between neighboring subdivision areas in the X-axis direction and the Y-axis direction, respectively.

The alignment cameras 75A, 75B, 75C and 75D shown in FIG. 2 are fixed to the lens barrel 50B of the projection optical system 50 by a supporting member (not shown) in accordance to the arrangement of the alignment marks P, i.e., the interval “PA” of the alignment marks P between the neighboring subdivision areas D1 and D2 (D3 and D4) in the X direction and the interval “PB” of the alignment marks P between the neighboring subdivision areas D1 and D3 (D2 and D4) in the Y direction.

In FIG. 3, the alignment cameras 75A, 75B, 75C and 75D are positioned to capture the alignment marks AM1, BM1, CM1 and DM1, respectively. And since the alignment marks AM1, BM1, CM1 and DM1 are within the visual fields 75a, 75b, 75c and 75d, the alignment cameras 75A, 75B, 75C and 75D can capture the alignment marks AM1, BM1, CM1 and DM1 simultaneously.

The controller 90 can shift the alignment cameras 75A, 75B, 75C and 75D along the sub-scanning direction (the Y-axis direction) from the situation shown in FIG. 3 to positions that capture the alignment marks AM2, BM2, CM2 and DM2 simultaneously. Similarly, the alignment cameras 75A, 75B, 75C and 75D can capture AM3, BM3, CM3 and DM3 and AM4, BM4, CM4 and DM4 simultaneously.

Based on such an arrangement of the alignment camera group 75, the alignment process shown in FIG. 4 is carried out during the laser process. The laser-processing unit 100 receives data associated with the substrate W mounted on the processing stage 70 from a computer such as a server, and stores the data in a memory (not shown). The subdivision areas D1 to D4 are determined based on received data including information associated with the size of the substrate W, predetermined positions of the alignment marks P and arrangement of the alignment marks P (Step S101).

The alignment cameras 75A to 75D capture the alignment marks P in order while the controller 90 moves the processing stage 70 in the X direction and the Y direction. Concretely, the controller 90 positions the substrate W in a first-capture position that allows the alignment cameras 75A, 75B, 75C and 75D to capture the alignment marks AM1, BM1, CM1 and DM1 simultaneously. After the shooting of the alignment marks AM1, AM2, AM3 and AM4, the controller 90 moves the processing stage 70 to a position that allows the alignment cameras 75A, 75B, 75C and 75D to capture the alignment marks AM2, BM2, CM2 and DM2 simultaneously.

Furthermore, the alignment cameras 75A, 75B, 75C and 75D capture the alignment marks AM3, BM3, CM3 and DM3 simultaneously and the alignment marks AM4, BM4, CM4 and DM3 simultaneously, by moving the processing stage 70. In FIG. 3, the path of the visual fields 75a, 75b, 75c and 75d depending upon the movement of the alignment cameras 75A, 75B, 75C and 75D are represented by using arrows A, B and C. The simultaneous shooting occurs at the four spots according to the positions of the respective measured alignment marks P (Step S102).

The position-relationship between the processing stage 70 and each alignment camera is measured beforehand by capturing a standard alignment mark (not shown) provided on the processing stage 70. Correction values for alignment are calculated from the measured positions of the alignment marks P and the position-relationship. Concretely, an amount of shifting (i.e., off set) along the X and Y directions, an amount of scaling and an amount of rotation on the X-Y plane are calculated (Step S103). The correction values are then calculated for each subdivision area.

The position of the processing stage 70 is adjusted based on the correction values that are calculated for each subdivision area, namely, a global alignment is carried out for each subdivision area and a laser ablation process is then carried out (Step S104).

The alignment process described above shortens measurement time and improves throughput by moving the alignment camera group 75 efficiently. Especially, because four alignment marks in four subdivision areas are captured simultaneously, the positions of all alignment marks can be measured by shooting four times.

Each of the alignment cameras 75A, 75B, 75C and 75D has an individual variation. For example, the level of accuracy achieved by fixing the lens barrel 50B via a supporting member varies with the alignment cameras 75A, 75B, 75C and 75D, and the performance associated with shooting slightly differs from one to another. As a result, when capturing alignment marks in one subdivision area by using plural cameras among the alignment cameras 75A, 75B, 75C and 75D, accuracy of alignment deteriorates.

In this embodiment, alignment marks P in each subdivision area are captured by one alignment camera. Thus, a throughput improves while maintaining accuracy of alignment.

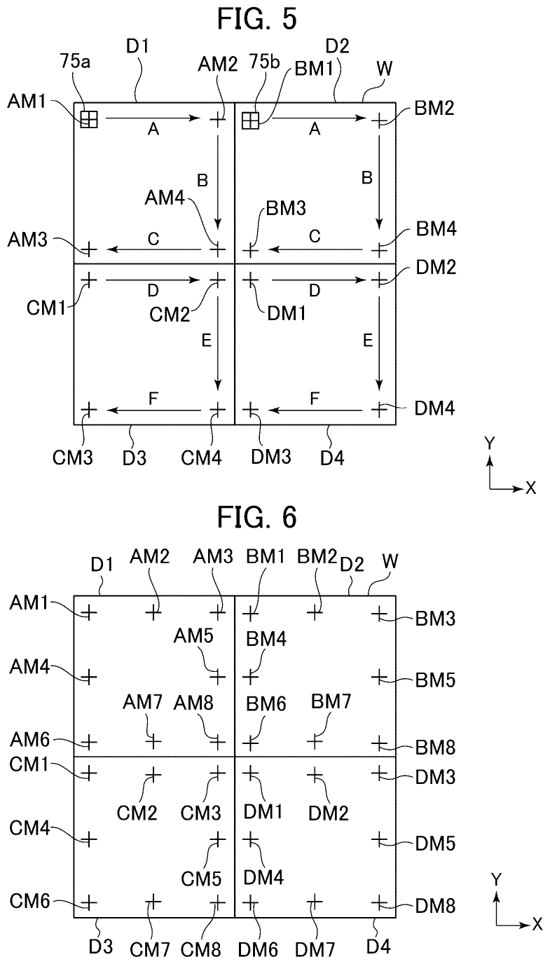

FIG. 5 illustrates a shooting method different from that shown in FIG. 3. The alignment cameras 75A and 75B are utilized for the four subdivision areas D1 to D4 and simultaneous shooting using a common alignment camera is carried out for each subdivision area.

As for the subdivision areas D1 and D2, the alignment marks AM1 and BM1 are captured simultaneously and the alignment marks AM2 and BM2 are then captured simultaneously. Furthermore, the alignment marks AM4 and BM4 are captured simultaneously and the alignment marks AM3 and BM3 are captured simultaneously.

Similarly, for the subdivision areas D3 and D4, the alignment marks CM1 and DM1 are captured simultaneously, the alignment marks CM2 and DM2 are captured simultaneously, the alignment marks CM4 and DM4 are captured simultaneously and the alignment marks AM3 and BM3 are captured simultaneously. The path of the movement of the visual fields 75a and 75b is represented by arrows A, B, C, D, E and F, and the shooting process using two alignment cameras improves throughput. Furthermore, two subdivision areas D1 and D3 (subdivision areas D2 and D4) are captured by one alignment camera so that individual variations among the alignment cameras 75A and 75B decreases.

FIG. 6 illustrates a substrate with a higher density of alignment marks than the alignment marks shown in FIG. 3.

Herein, eight alignment marks are formed along the boundaries of each subdivision area. The alignment marks AM1 to AM8 for the subdivision area D1 are captured by the alignment camera 75A. Similarly, the alignment marks BM1 to BM8 for the subdivision area D2 are captured by the alignment camera 75B, the alignment marks CM1 to CM8 for the subdivision area D3 are captured by the alignment camera 75C and the alignment marks DM1 to DM8 for the subdivision area D4 are captured by the alignment camera 75D. Since the positions of the alignment marks for each subdivision area are the same as each other, simultaneous shooting can be carried out.

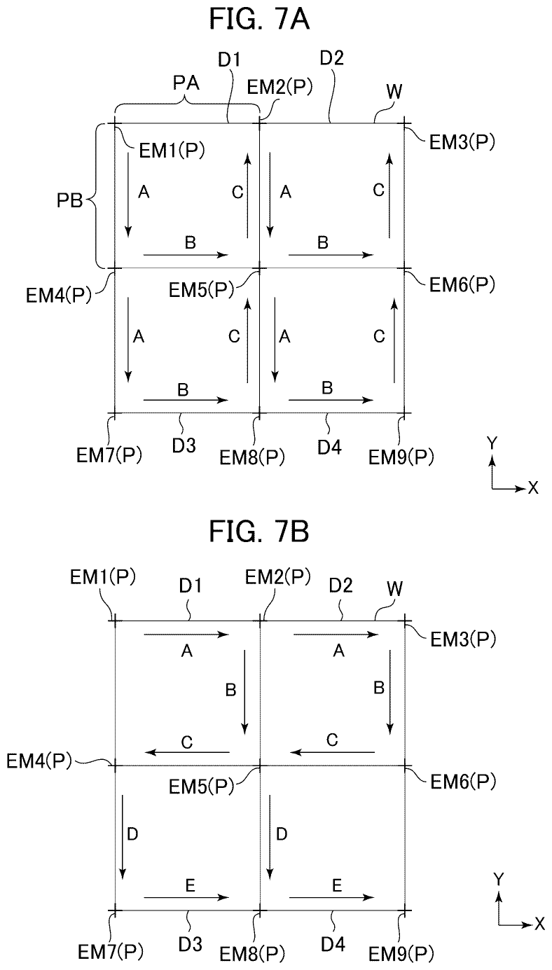

FIGS. 7A and 7B illustrate a substrate in which alignment marks are positioned differently from those shown in FIG. 3.

In the substrate W, the subdivision areas D1 to D4 are defined such that alignment marks P are positioned at vertices. Herein, eight alignment marks EM1 to EM8 are located on the boundaries of the subdivision areas D1 to D4, which are shared with neighboring subdivision areas. The alignment cameras 75A to 75D are fixed to the lens barrel 50B at intervals “PA” and “PB” that correspond to the lengths of the sides of each subdivision area in the X and Y directions.

In FIG. 7A, simultaneous shooting is carried out by using the four alignment cameras 75A, 75B, 75C and 75D. The path of the movement of visual fields 75a, 75b, 75c and 75d, i.e., the alignment cameras 75A to 75D, is represented by Arrows A, B and C.

The alignment marks EM2, EM5 and EM8 are captured by different alignment cameras. For example, the position of the alignment mark EM2 measured by the alignment camera 75A is utilized to an alignment of the subdivision area D1 and the position of the alignment mark EM2 measured by the alignment camera 75B is utilized to an alignment of the subdivision area D2. On the other hand, since there are individual variations between the alignment cameras 75A, 75B, 75C and 75D, the correction values may be modified or corrected by calculating an average value.

On the other hand, In FIG. 7B, simultaneous shooting using the two alignment cameras 75A and 75B is carried out. In FIG. 7B, the path of the movement of the alignment cameras 75A and 75B is represented by Arrows A to E. The shooting using one alignment camera is carried out the same for the subdivision areas D1 and D3 as for subdivision areas D2 and D4. Therefore, the measured positions of the alignment marks for subdivision areas D1 and D3 may be shared. The measured positions of the alignment marks for subdivision areas D2 and D4 may be also shared. In this case, global alignments for the subdivision areas D1 and D3 and the subdivision areas D2 and D4 are carried out by one alignment camera, respectively.

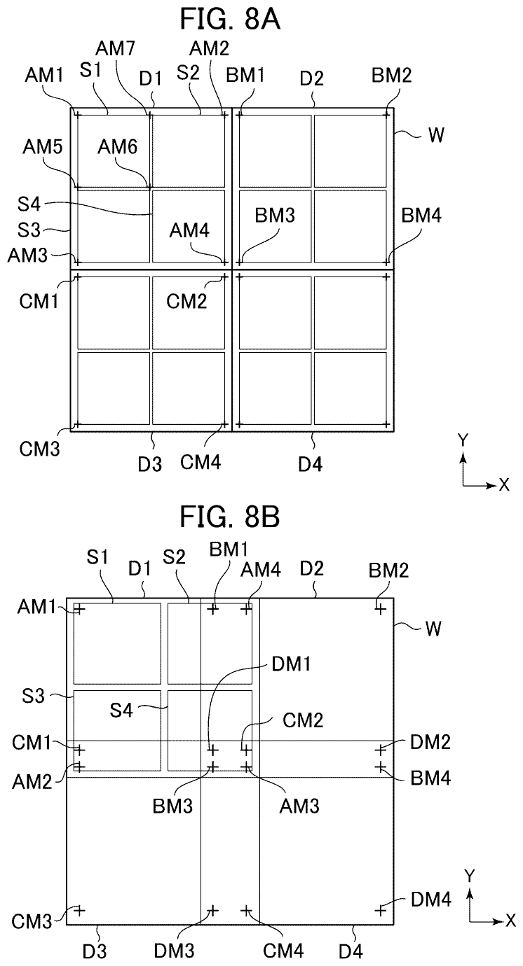

FIGS. 8A and 8B illustrate a substrate in which subdivision areas including a plurality of scanning areas are defined, which are different from those shown in FIGS. 3 and 5 to 7.

In the laser-processing unit 100, one scanning area of the line-shaped laser beam LB is defined as a processing area. Each subdivision area encompasses a plurality of processing areas. In FIG. 8A, four processing areas S1 to S4 are included in the subdivision area D1. The subdivision areas D2, D3 and D4 also include four processing areas, respectively (not shown).

In each processing area, four alignment marks are formed at vertices in the processing area. For example, In the processing area S1, alignment marks AM1, AM5, AM6 and AM7 are formed at the vertices in the processing area S1. Thus, accuracy of alignment can be enhanced for each processing area.

On the hand, alignment marks may be only formed at the corners of each subdivision area. In this case, the number of alignment marks decreases, which shortens measurement time. Since a shooting for one subdivision area is carried out by a common alignment camera, the size of a processing area, i.e., the amount of processing in one subdivision area, can be arbitrarily and optionally set according to a specification or state of the substrate W.

In FIG. 8B, subdivision areas overlap with one another. Processing areas are determined in accordance to a pattern to be formed on the substrate W and processing areas are extremely close to one another and overlap with one another depending on the case. When equally dividing the total area of the substrate W to define subdivision areas, a processing area occasionally extends or spills across the boundaries of subdivision areas. Herein, the subdivision areas D1 to D4 overlap with one another so that processing areas S1, S2, S3 and S4 do not extend across the boundaries of the subdivision areas D1 to D4. Similarly, the other processing areas (not shown) do not extend or spill across the boundaries of the subdivision areas D1 to D4.

As for the subdivision area D1, the capture of the alignment marks AM1 to AM4 is carried out by using the alignment camera 75A. Similarly, the capture of the alignment marks BM1 to BM4 in the subdivision area D2 is carried out by using the alignment camera 75B, the capture of the alignment marks CM1 to CM4 in the subdivision area D3 is carried out by using the alignment camera 75C and the capture of the alignment marks DM1 to DM4 in the subdivision area D4 is carried out by using the alignment camera 75D.

Regardless of the size or arrangement of a processing area, alignment marks included in each subdivision area are captured by a common alignment camera. Thus, accuracy of alignment can be maintained.

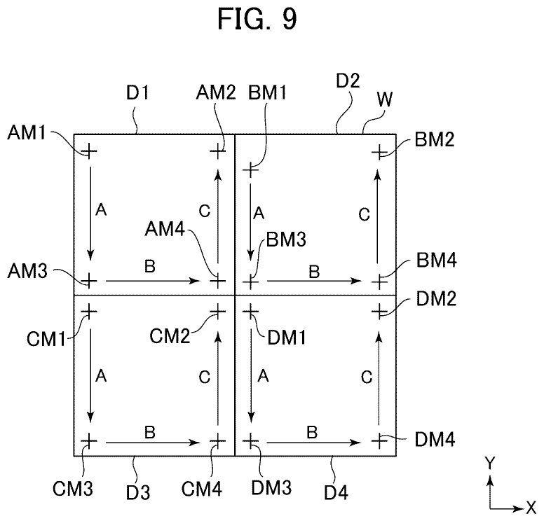

FIG. 9 illustrates a substrate in which positions of alignment marks vary with respect to subdivision areas.

In the substrate W, the position of the alignment mark BM1 in the subdivision area D2 is different from the corresponding alignment mark AM1 in the subdivision area D1. The alignment camera 75B cannot capture the alignment mark BM1 since the position of the alignment mark BM1 deviates from the visual field 75b (see FIG. 3).

Consequently, the alignment marks AM1, CM1 and DM1 are captured by the alignment cameras 75A, 75C and 75D, respectively. The alignment mark BM1 is then captured with the alignment camera 75B by moving the processing stage 70 in the sub-scanning direction (the Y direction). Such a shooting in turn can be carried out for another subdivision area in which an alignment mark is formed in a different position.

In this way, when carrying out an alignment process, the subdivision areas D1 to D4 are defined in accordance to the array of the alignment marks P, the scanning area, etc. The alignment cameras 75A to 75D arranged around the lens barrel 50B are spaced apart from one another at even intervals that correspond to the size of the subdivision areas. Alignment marks included in each subdivision area are captured by a common alignment camera.

Five or more subdivision areas or two to three subdivision areas may be defined. Scanning-areas may be directly aligned with subdivision areas. In this case, alignment marks are formed along the boundaries of the scanning-areas, which allows for enhanced accuracy of alignment.

A laser-processing unit with a Galvanometer scanner may be applied in place of the laser-processing unit 100 with the mask M. The camera 65 for capturing the mask M may be utilized in an alignment process together with the alignment camera group 75.

The alignment cameras 75 may be fixed to a member other than the lens barrel 50B of the projection optical system 50. The positions of the alignment cameras 75 may be adjusted by an actuator. For example, in the case of FIG. 9, when capturing the alignment mark BM1, the alignment camera 75B may be moved by an actuator instead of the movement of the processing stage 70.

An alignment process for a subdivision area may be carried out based on correction values that are calculated for another subdivision area, which improves throughput.

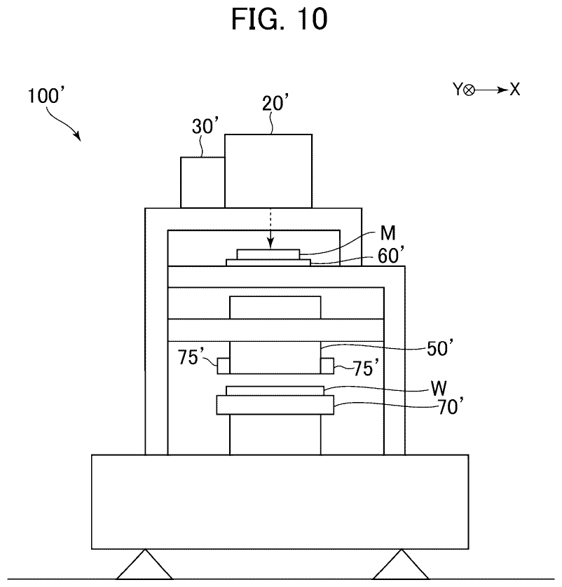

FIG. 10 is a schematic view of an exposure unit according to another embodiment.

The exposure unit 100′ has an exposure head 20′, a light source 30′, a projection optical system 50′, a mask stage 60′, a processing stage 70′ and an alignment camera group 75′. An alignment process is carried out similarly to the laser-processing unit 100. In this case, a one-shot area corresponds to a scanning-area. A maskless exposure unit may be also applied. A processing unit that processes a workpiece associated with a semiconductor may be applied.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2025-050972 (filed on Mar. 26, 2025), which is expressly incorporated herein by reference, in its entirety.

1. A method for alignment of a workpiece, comprising:
arranging a plurality of alignment cameras for a processing-unit for processing a workpiece;
setting a plurality of subdivision areas in the workpiece based on array of alignment marks formed on the workpiece; and
capturing alignment marks included in a subdivision area by a common alignment camera used for respective subdivision areas.

2. The method according to claim 1, wherein the capturing comprises capturing alignment marks in respective subdivision areas simultaneously by using at least two alignment cameras.

3. The method according to claim 1, wherein the arranging comprises aligning a spacing of said alignment cameras with a center interval between neighboring subdivision areas.

4. The method according to claim 1, wherein the capturing comprises capturing alignment marks in respective subdivision areas in turn by using at least two alignment cameras.

5. The method according to claim 1, further comprises carrying out a global alignment for each subdivision area based on measured positions of the alignment marks.

6. The method according to claim 1, further comprises carrying out a global alignment for at least two subdivision areas based on positions of alignment marks captured by one alignment camera among said plurality of alignment cameras.

7. The method according to claim 1, wherein the plurality of subdivision areas includes a plurality of processing areas, each processing area corresponding to one shooting area or one scanning area of said processing unit.

8. The method according to claim 1, wherein the capturing comprises capturing alignment marks included in a processing area by a common alignment camera used for respective processing areas, each processing area corresponding to one shooting area or one scanning area of said processing unit.

9. The method according to claim 1, wherein the setting comprises setting a plurality of subdivision areas that overlap with one another, the plurality of subdivision areas including at least one processing area respectively, the at least one processing area not crossing the boundaries of the subdivision areas, each processing area corresponding to one shooting area or one scanning area of said processing unit.

10. The method according to claim 1, wherein the capturing comprises capturing the plurality of alignment marks by moving a processing stage provided in said processing unit, the workpiece being mounted on said processing stage.

11. An apparatus for alignment of a workpiece, comprising:
a plurality of alignment cameras configured to be arranged spaced apart from one another at a predetermined interval corresponding to a center interval between neighboring subdivision areas that are defined on the workpiece;
a processing stage, the workpiece being mounted on said processing stage; and
a controller configured to control an alignment process, said controller controlling said processing stage or said plurality of alignment cameras to capture alignment marks included in a subdivision area by a common alignment camera used for respective subdivision areas.

12. The apparatus according to claim 11, wherein said controller controls said processing unit or said plurality of alignment cameras to capture alignment marks in respective subdivision areas simultaneously by using at least two alignment cameras.
